(19) United States
(12) Patent Application Publication
(10) Pub. No.: US 2014/0097275 A1
(43) Pub. Date: Apr. 10, 2014

(54) FUEL INJECTOR WITH NOZZLE PASSAGES HAVING ELECTROLESS NICKEL COATING

(71) Applicant: CATERPILAR INC., Peoria, IL (US)

(72) Inventors: Huijun Wang, Peoria, IL (US); Marion Grant, Princeville, IL (US); Hind Abi-Akar, Peoria, IL (US)

(73) Assignee: CATERPILLAR INC., Peoria, IL (US)

(21) Appl. No.: 13/648,655

(22) Filed: Oct. 10, 2012

(51) Int. Cl. F02M 61/18; B21C 23/24; F02M 61/10

(52) U.S. Cl. 239/584; 72/47

(57) ABSTRACT

Problems associated with soot production and coking build up in nozzle spray passages are addressed by plating a bore wall of an injector body tip piece with a primarily nickel coating using an electroless plating technique. The coating has an average thickness that is at least one order of magnitude smaller than an average diameter of the bore.

### TECHNICAL FIELD

The present disclosure relates generally to an anti-coking strategy for nozzle spray passages of a fuel injector, and more particularly to electrolessly plated nozzle spray passages with a primarily nickel coating.

### BACKGROUND

The conventional wisdom in reducing certain emissions, such as soot, can be accomplished by employing ever higher injection pressures coupled with smaller diameter nozzle spray orifices. While a number of different strategies exist for boring tiny nozzle passages in injector tip pieces, each strategy has limitations. For instance, so called electrical discharge machining (EDM) strategies reach their limit at a bore size on the order of about 100 micrometers. Smaller EDM bores show too many irregularities. But the conventional wisdom suggests that substantial improvements in reducing soot through better atomization of fuel spray can be achieved with nozzle spray passages on the order of about 50 micrometers. In response to this perceived need, Argonne National Laboratories taught a strategy for reducing an initial bore size of about 200 micrometers down to about 50 micrometers by plating the bore walls with a relatively thick coating of primarily nickel applied through known electroless plating techniques. See Fabrication of Small-Orifice Fuel Injectors for Diesel Engines, ANL Report, March 2005. Although some of the reported Argonne Laboratories results appeared promising, new problems developed as the relatively thick coating required long plating time periods, rendering the strategy difficult to imagine on an industrial scale. In addition, Argonne reported problems associated with removal of certain gaseous bi-products of the plating process from the region being plated.

Apart from finding an effective nozzle bore passage size is the problem of orifice coking over time. In general, the minute quantity of liquid diesel fuel that remains in the nozzle bore after the end of an injection event combined with the high temperatures in the engine cylinder can create the development of coking on the bore wall of a nozzle passage. While some coking development is almost inevitable, each subsequent injection event may effectively flush out the coking products from a previous injection event. However, if even a small quantity of coking material manages to remain adhered to the bore wall, it may also be inevitable that a coking build up will relentlessly occur until the nozzle passage actually becomes blocked, undermining the operation of the entire fuel system. Thus, finding an effective injection pressure strategy combined with an appropriate nozzle orifice geometry that not only reduces soot but inhibits coking build up has remained a persistent problem in the fuel injection art.

The present disclosure is directed toward one or more of the problems set forth above.

### SUMMARY

In one aspect, a tip piece of a multi-piece fuel injector body includes a unitary steel body with a centerline and an inner surface separated from an outer surface by an annular contact surface. The inner surface defines a nozzle chamber separated from a sac by a needle valve seat. A plurality of bores extend between the sac and the outer surface. Each of the bores has an average diameter defined by a bore wall. A primarily nickel coating is plated to the bore wall to define a spray passage. The coating has an average thickness that is at least one order of magnitude smaller than the average diameter.

In another aspect, a fuel injector includes a multi-piece injector body with a centerline, and includes a tip piece that is a unitary steel body with an inner surface separated from an outer surface by an annular contact surface in contact with another injector body piece. The inner surface defines a nozzle chamber separated from a sac by a needle valve seat. A plurality of bores extend between the sac and the outer surface. Each the bores has an average diameter defined by a bore wall. A primarily nickel coating is plated to the bore wall to define a spray passage, and the coating has an average thickness that is at least one order of magnitude smaller than the average diameter. A needle valve member is positioned in the injector body and is movable between a closed position in contact with the needle valve seat to block the nozzle chamber to the spray passages, and an open position out of contact with the needle valve seat to fluidly connect the nozzle chamber to the spray passages.

In still another aspect, a method of making a fuel injector includes forming a unitary body of steel to include an inner surface separated from an outer surface by an annular contact surface, with the inner surface defining a nozzle chamber separated from a sac by a needle valve seat. A plurality of bores are electrical discharge machined between the outer surface and the sac, and each of the bores has an average diameter defined by a bore wall. A primarily nickel coating is electrolessly plated to the bore wall with an average thickness that is at least one order of magnitude smaller than the average diameter.

### BRIEF DESCRIPTION OF THE DRAWINGS

FIG. 1 is a sectioned front diagrammatic view of a fuel injector according to the present disclosure;

FIG. 2 is an enlarged view of the nozzle portion of the fuel injector of FIG. 1;

FIG. 3 is an enlarged sectioned view of one spray passage for the fuel injector of FIG. 1;

FIG. 4 is a further enlargement of a segment of the spray passage shown in FIG. 3;

FIG. 5 is a further enlargement of a segment of the bore wall prior to plating according to another aspect of the present disclosure;

FIG. 6 shows the bore wall of FIG. 5 after being smoothed with an abrasive slurry;

FIG. 7 shows the bore wall of FIG. 6 after being electrolessly plated with a primarily nickel coating; and

FIG. 8 is an enlarged sectioned view of a segment of a spray passage similar to that of FIG. 4 except showing the prior art geometry and plating thicknesses taught by Argonne National Laboratories.

### DETAILED DESCRIPTION

Referring initially to FIG. 8, and end segment of a nozzle spray passage 139 constructed according to the teachings of Argonne Labs shows a bore diameter of about 200 micrometers formed in a tip piece 112 of an injector body with conventional electrical discharge machining (EDM). The bore is reduced in diameter down to about 50 micrometers into a spray passage 139 by depositing a primarily nickel coating 150 onto the bore wall using conventional electroless nickel plating techniques. The end result is a nickel coating with a thickness on the order of about 75 micrometers that includes a transition contour 151 to the outer surface of the tip piece 112 with an average radius that may actually exceed the spray passage diameter of 50 micrometers. While the Argonne Lab's strategy can be used to successfully make small diameter spray passages 139, better soot reduction through better atomization may not be the end result as hoped for. In particular, the relatively large radius transition contour 151 is believed to undermine fuel atomization, and the prolonged plating time along with gas development during the plating procedure might result in less than smooth surfaces that define the spray passage 139. The transition contour issue may undermine the better atomization hoped for through the smaller diameter spray passages, and surface roughness may contribute to coking problems after the tip piece is put into service. For reasons not completely understood, coking problems with fuel injectors appear to increase with increased injection pressures. Thus, the strategy taught by Argonne Lab's may not produce results substantially better than existing fuel injectors with untreated EDM nozzle passages with diameters greater than 100 micrometers.

Recognizing that injection pressures are likely to continue rising, the present disclosure seeks to leverage at least two insights to simultaneously improve or at least maintain good spray atomization to reduce soot, while also addressing coking build up problems that appear to have accompanied current day increased injection pressures. These goals are addressed by maintaining a relatively square transition contour from the end of the spray passage to the other surface of the fuel injector tip piece, producing a smaller diameter spray passage than a conventional EDM strategy, and producing a spray passage wall chemistry and smoothness that inhibits coking build up after the fuel injector is in service. Finally, the present disclosure seeks to accomplish these improvements without adding the new gaseous discharge and other problems recognized by Argonne as a result of long plating periods to produce the rather thick coating of its spray passages.

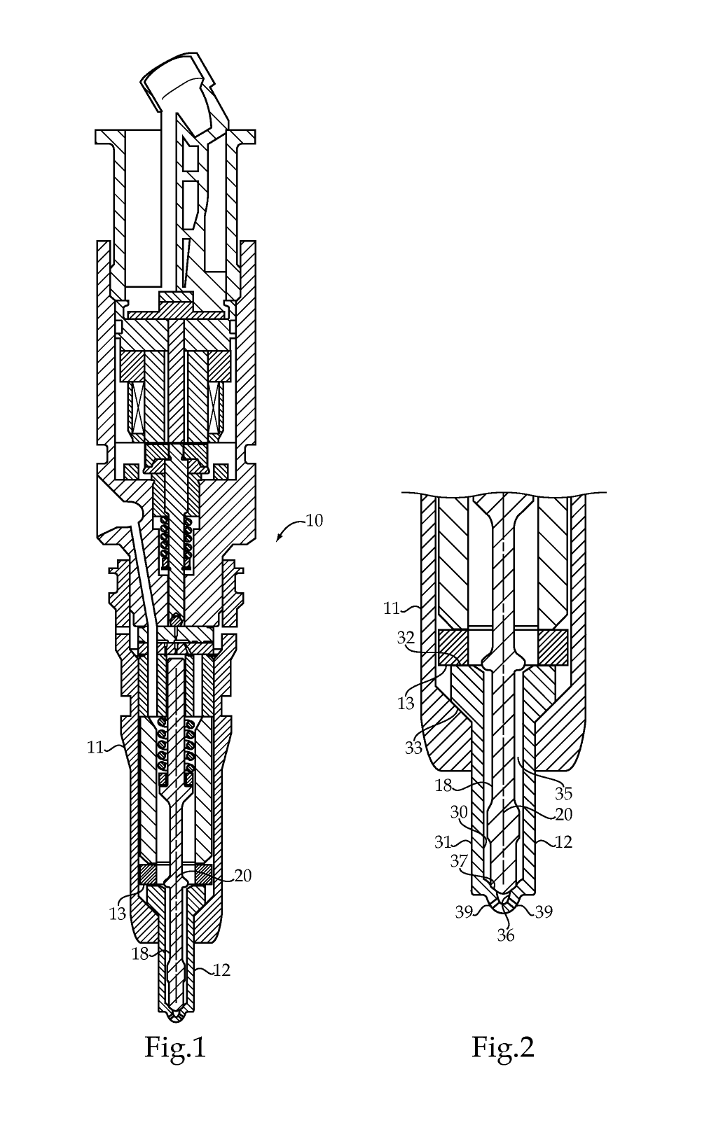

Referring to FIGS. 1 and 2, a fuel injector 10 includes a multi-piece injector body 11 with a centerline 20. The multi-piece injector body 11 may include a tip piece 12 with an inner surface 30 separated from an outer surface 31 by an annular contact surface 32 that is contact with another injector body piece 13. The inner surface 30 defines a nozzle chamber 35 separated from a sac 36 by a needle valve seat 37. The tip piece 12 defines a plurality of spray passages 39 that extend between sac 36 and outer surface 31. A needle valve member 18 is positioned in the injector body, and is movable between a closed position in contact with the needle valve seat 37 (as shown) to block the nozzle chamber 35 to the spray passages 39, and an open position out of contact with the needle valve seat 37 to fluidly connect the nozzle chamber 35 to the spray passages 39. Although not necessary, the tip piece 12 may also include an outer seal seat 33 that contacts a casing component 16 of multi-piece injector body 11 in a conventional manner. Although fuel injector 10 could be utilized in association with any fuel, the present disclosure finds particular applicability with regard to liquid diesel fuel such that nozzle chamber 35 contains diesel fuel at an injection pressure.

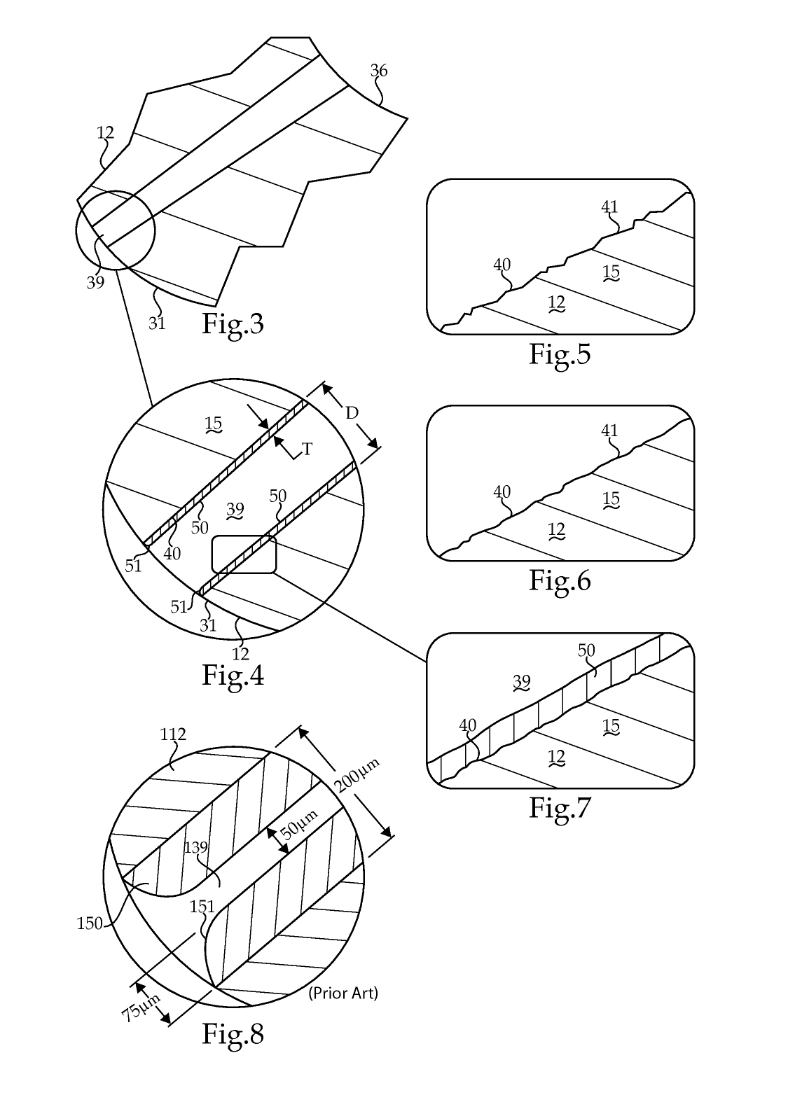

Referring now to FIGS. 3-7, each spray passage 39 begins as a bore 40 that extends between the sac 36 and the outer surface 31. Each of the bores has an average diameter D defined by a bore wall 41. Although not necessary, the bores may be formed using conventional EDM techniques, and the average diameter D may be between 100 and 400 micrometers. Those skilled in the art will appreciate that, prior to plating, the size, shape and geometry of tip piece 12 may be formed from a unitary steel body 15 of a suitable alloy. A primarily nickel coating 50 is plated to the bore wall 41 to define the spray passages 39. The coating 50 has an average thickness T that is at least one order of magnitude smaller than the average diameter D. The phrase “order of magnitude” means ten. Thus, at least one order of magnitude means at least ten times. Nine is not at least one order of magnitude whereas eleven is at least one order of magnitude. In most instances, a coating 50 with a thickness T that is less than 10 micrometers would be an appropriate thickness according to the present disclosure. In many instances, a thickness T of 5 micrometers may suffice.

Referring specifically to FIG. 5, after the bore 40 is made using a conventional EDM boring process, the bore wall 41 may have a surface roughness of 1-2 micrometers R_{z}, or more. It is believed that this surface roughness, if left untreated, may present locations where a cooking build up can take hold and eventually undermine performance. Although the coating 50 may be applied directly to bore wall 41 after the EDM process, it may be possible to utilize thinner coatings 50 if the bore wall is pretreated with an abrasive slurry to smooth out the surface roughness as shown in FIG. 6. Whether or not the bore wall 41 is abraded using an abrasive slurry, the primarily nickele coating 50 is applied using conventional electroless plating techniques. Those skilled in the art will appreciate that the plating technique tends to smooth the roughness of the underlying bore wall 40. FIG. 7 shows that the end product exposed surface of the primarily nickel coating 50 still is not entirely smooth but has an acceptable waviness such that spray passage 39 does not have an exact uniform diameter. However, the spray passage 39 is substantially smoother and may have surface roughness R_{z} that is at least one order of magnitude smaller than the surface roughness of the bore wall 41 immediately after the EDM boring process. This substantial reduction in surface roughness may contribute to preventing coking deposits from taking hold and then building up thereafter. Thus, each subsequent injection event may flush out any coking material that may have chemically developed in spray passage 39 between injection events.

Because the present disclosure teaches a relatively thin coating of primarily nickel 50, the transition contour 51 from the spray passage 39 to the outer surface 31 can be magnitudinally square relative to average diameter D. As used in this disclosure, the phrase “magnitudinally square” means that the transition contour 51 has an average radius that is at least one order of magnitude smaller than the average diameter D. Those skilled in the art will appreciate that the primarily nickel coating 50 may include one or more other substances in addition to nickel. However, primarily nickel coating means that a majority of the material present in coating 50 is nickel. Other substances that may be utilized include, but are not limited to, phosphorus, cobalt and maybe even PTFE. These secondary substances may be chosen to make the surface of spray passage 39 more chemically inert to the adherence of coking products and may be chosen for their ability to produce a smoother contour that defines spray passage 39. These added substances may be co-plated with the electroless nickel at any concentration as would be deemed appropriate to one with ordinary skill in the art. The present disclosure suggests that a combination of chemical inertness and smoothness in the spray passage 39 can inhibit coking products from taking hold and then building up thereafter to potentially block a spray passage. The present disclosure recognizes that the chemical changes in residual fuel left in spray passage 39 between injection events and subjected to the heat of an engine cylinder may inherently produce some carbonizing or coking products. However, by presenting a more chemically inert and smoother spray passage surface, these inevitable coking products may be flushed out of spray passages 39 with each subsequent injection event.

### INDUSTRIAL APPLICABILITY

The present disclosure finds potential applicability in any fuel injector. The present disclosure finds particular applicability with regard to tip pieces for use in fuel injectors that inject diesel fuel into compression ignition engines. The present disclosure might also find potential applicability to any fuel injector where there may be a desire to improve at least one of spray atomization to potentially reduce soot and prevent or inhibit coking build up that can occur after the fuel injector is put into service.

The present disclosure teaches a method of making a fuel injector that includes forming a unitary steel body 15 to include an inner surface 30 separated from an outer surface 31 by a contact surface 32. The inner surface 30 is formed to define a nozzle chamber 35 separated from a sac 36 by a needle valve seat 37. A plurality of bores 40 are electrical discharge machined between the outer surface 31 and the sac 36. Each of the bores 40 has an average diameter D defined by a bore wall 41. A primarily nickel coating 50 is electrolessly plated to the bore wall 41 with an average thickness T that is at least one order of magnitude smaller than the average diameter D. Although not necessary, any sharp peaks that are left by the electrical discharge machine process may be abraded by passing an abrasive slurry through the bores before the plating step. In addition, although not necessary, the primarily nickel coating 50 may be heat treated using a known techniques to strengthen or otherwise improve some characteristic of the primarily nickel coating 50 after the plating step. Finally, a multi-piece injector body 11 is assembled by contacting the annular contact surface 32 with another injector body piece 13. Next, a needle valve member 18 is positioned in the nozzle chamber 35 in contact with the needle valve seat 37.

The present disclosure recognizes that improved performance may be obtained in reducing soot production by utilizing higher injection pressures, slightly smaller spray passage diameters due to the plating thickness and a magnitudinally square transition contour 51 from the spray passage 39 to the outer surface 31 of tip piece 12. The chemical inertness and/or smoothness provided by the primarily nickel coating 50 is believed to inhibit adherence and build up of coking and carbonizing molecules on the spray passage surface between injection events. This may allow the spray passage to remain reliably open with a substantially unchanged spray configuration over the working life of a given fuel injector.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A tip piece of a multi-piece fuel injector body comprising:
a unitary steel body with a centerline and an inner surface separated from an outer surface by an annular contact surface;
the inner surface defining a nozzle chamber separated from a sac by a needle valve seat;
a plurality of bores that extend between the sac and the outer surface;
each of the bores has an average diameter defined by a bore wall;
a primarily nickel coating plated to the bore wall to define a spray passage, and the coating having an average thickness that is at least one order of magnitude smaller than the average diameter.

2. The tip piece of claim 1 wherein the bore wall has a surface roughness of 1-2 micrometers Rz.

3. The tip piece of claim 1 wherein the average diameter is between 100 and 400 micrometers.

4. The tip piece of claim 1 wherein the average thickness is less than 10 micrometers.

5. The tip piece of claim 1 wherein the spray passage has a transition contour to the outer surface that is magnitudinally square relative to the average diameter.

6. The tip piece of claim 1 wherein the bore wall has a surface roughness of 1-2 micrometers Rz;
the average diameter is between 100 and 400 micrometers;
the average thickness is less than 10 micrometers; and
the spray passage has a transition contour to the outer surface that is magnitudinally square relative to the average diameter.

7. A fuel injector comprising:
a multi-piece injector body with a centerline and includes a tip piece that is a unitary steel body with an inner surface separated from an outer surface by an annular contact surface in contact with another injector body piece;
the inner surface defining a nozzle chamber separated from a sac by a needle valve seat;
a plurality of bores that extend between the sac and the outer surface;
each of the bores has an average diameter defined by a bore wall;
a primarily nickel coating plated to the bore wall to define a spray passage, and the coating having an average thickness that is at least one order of magnitude smaller than the average diameter;
a needle valve member positioned in the injector body and being movable between a closed position in contact with the needle valve seat to block the nozzle chamber to the spray passages, and an open position out of contact with needle valve seat to fluidly connect the nozzle chamber to the spray passages.

8. The fuel injector of claim 7 wherein the bore wall has a surface roughness of 1-2 Rz.

9. The fuel injector of claim 7 wherein the average diameter is between 100 and 400 micrometers.

10. The fuel injector of claim 7 wherein the average thickness is less than 10 micrometers.

11. The fuel injector of claim 7 wherein the spray passage has a transition contour to the outer surface that is magnitudinally square relative to the average diameter.

12. The fuel injector of claim 7 wherein the bore wall has a surface roughness of 1-2 micrometers Rz;
the average diameter is between 100 and 400 micrometers;
the average thickness is less than 10 micrometers; and
the spray passage has a transition contour to the outer surface that is magnitudinally square relative to the average diameter.

13. The fuel injector of claim 12 wherein the nozzle chamber contains diesel fuel at an injection pressure.

14. The fuel injector of claim 7 wherein the nozzle chamber contains diesel fuel at an injection pressure.

15. A method of making a fuel injector comprising the steps of:
forming a unitary body of steel to include an inner surface separated from an outer surface by an annular contact surface, and the inner surface defining a nozzle chamber separated from a sac by a needle valve seat;
electrical discharge machining a plurality of bores between the outer surface and the sac, and each of the bores has an average diameter defined by a bore wall;
electrolessly plating a primarily nickel coating to the bore wall with an average thickness that is at least one order of magnitude smaller than the average diameter.

16. The method of claim 15 including a step of abrading sharp peaks of the bore wall by passing an abrasive slurry through the bores between the electrical discharge machining step and the plating step.

17. The method of claim 15 including a step of heat treating the primarily nickel coating after the plating step.

18. The method of claim 15 including a step of assembling an injector body by contacting the annular contact surface with another injector body piece;
positioning a needle valve member in the nozzle chamber in contact with the needle valve seat.

19. The method of claim 15 including a step of abrading sharp peaks of the bore wall by passing an abrasive slurry through the bores between the electrical discharge machining step and the plating step; and
heat treating the primarily nickel coating after the plating step.

20. The method of claim 19 including a step of assembling an injector body by contacting the annular contact surface with another injector body piece;
positioning a needle valve member in the nozzle chamber in contact with the needle valve seat.
